(19) United States
(12) Patent Application Publication
(10) Pub. No.: US 2011/0277717 A1
(43) Pub. Date: Nov. 17, 2011

(54) INTAKE MANIFOLD

(75) Inventors: Wayne Groleau, Beverly Hills, MI (US); Christopher K. Clarke, Commerce Twp., MI (US); David Charles Klemstine, Lake Orion, MI (US)

(73) Assignee: GM GLOBAL TECHNOLOGY OPERATIONS LLC, Detroit, MI (US)

(21) Appl. No.: 12/981,729

(22) Filed: Dec. 30, 2010

Related U.S. Application Data
(60) Provisional application No. 61/345,357, filed on May 17, 2010.

(51) Int. Cl. F02M 35/104

(52) U.S. Cl. 123/184.34

(57) ABSTRACT

An intake manifold assembly for mounting to a cylinder head and configured to deliver combustion air thereto comprises a centrally positioned zip tube having an opening for receipt of combustion air from a throttle body. First and second flow runners extend from the centrally positioned zip tube to terminate at a common intake manifold plenum for delivery of combustion air thereto. A centrally located access opening is defined between the first and second flow runners.

### RELATED APPLICATIONS

This application claims priority of U.S. Provisional Patent Application Ser. No. 61/345,357 filed May 17, 2010, which is incorporated herein by reference.

### FIELD OF THE INVENTION

Exemplary embodiments of the present invention relate to intake systems for internal combustion engines and, more particularly, to a compact and fluidly efficient intake manifold assembly having a bifurcated zip tube for efficient delivery of combustion air to the engine.

### BACKGROUND

With the increased focus on vehicle economy, particularly vehicle fuel economy, automotive manufacturers are turning to smaller, lighter vehicles and unique vehicle powertrains to boost efficiency. As vehicle packaging parameters become increasingly compact, the reduced size may require unique configurations of traditional engine components.

### SUMMARY

In an exemplary embodiment an intake manifold assembly for mounting to a cylinder head and configured to deliver combustion air thereto comprises a centrally positioned zip tube having an opening for receipt of combustion air from a throttle body, first and second flow runners extending from the centrally positioned zip tube to terminate at a common intake manifold plenum for delivery of combustion air thereto, and a centrally located access opening defined between the first and second air flow runners.

In another exemplary embodiment, an intake manifold assembly for mounting to a cylinder head and configured to deliver combustion air thereto comprises a centrally positioned zip tube including having an opening for receipt of combustion air from a throttle body, first and second flow runners extending from the centrally positioned zip tube to terminate at axially remote ends of a common intake manifold plenum and a centrally located access opening defined between the second and third flow runners.

The above features and advantages, and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a perspective view of an internal combustion engine embodying features of the invention;

FIG. 2 is a top view of an intake manifold assembly for the engine of FIG. 1 embodying features of the invention;

FIG. 3 is a top view of another embodiment of an intake manifold assembly for the engine of FIG. 1 embodying features of the invention;

FIG. 4 is an air core diagram of the intake manifold assembly of FIG. 3; and

FIG. 5 is an air core diagram of the intake manifold assembly of FIG. 2.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

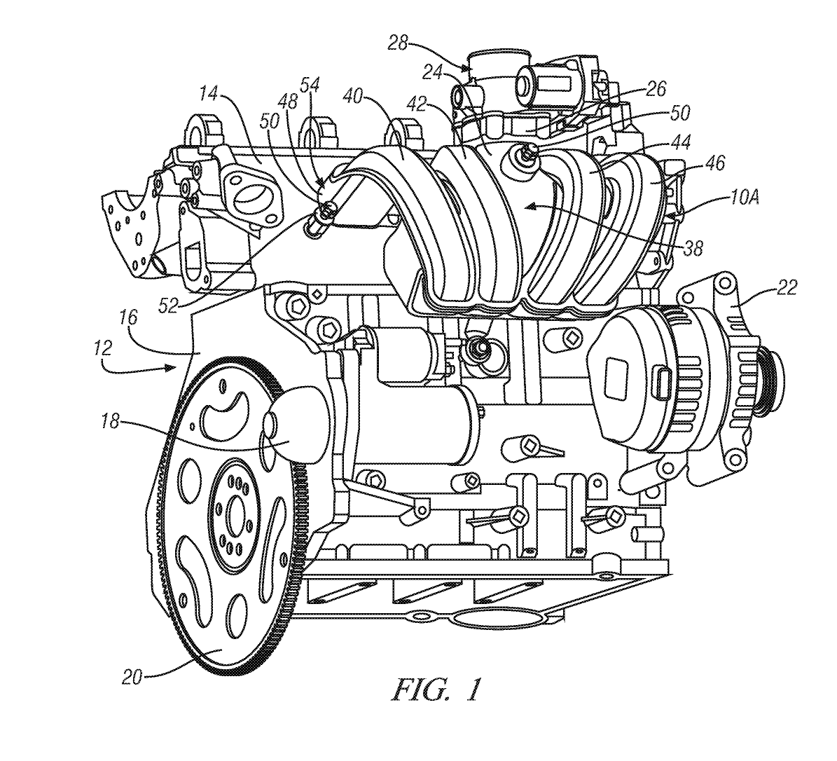

Referring now to FIG. 1, an exemplary embodiment of the invention is directed to an intake manifold assembly 10 that is configured to deliver combustion air to a cylinder head 14 of an internal combustion engine 12. The cylinder head 14 is mounted to a cylinder block 16 as are other components such as a rear mounted starter 18 that engages and rotates a toothed flywheel 20 during a starting mode, and a front mounted belt driven alternator 22.

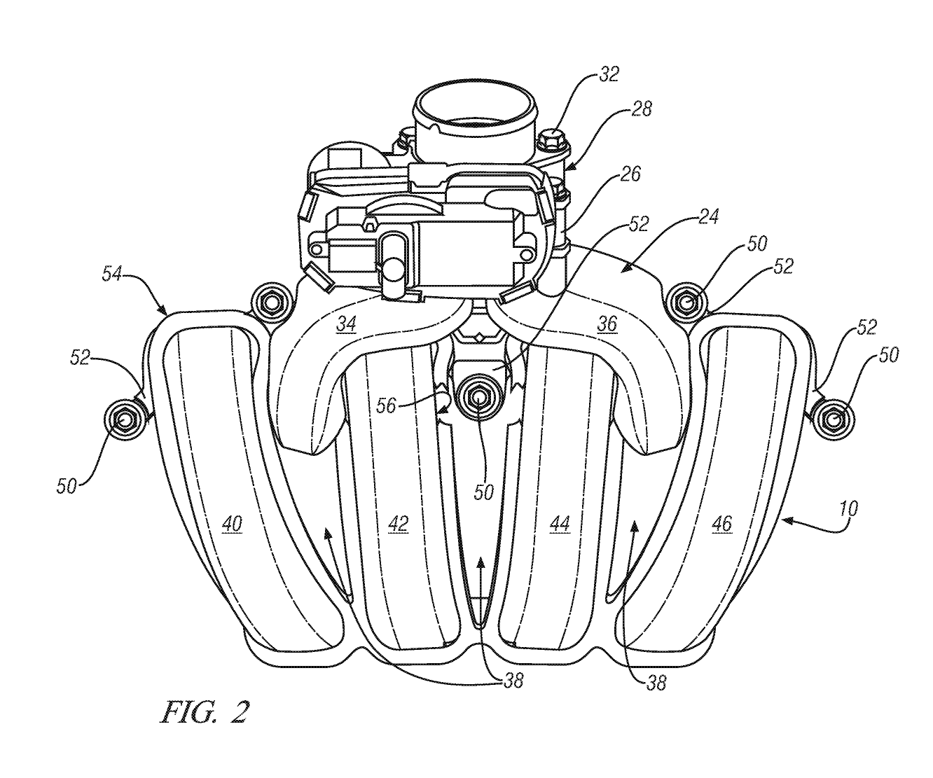

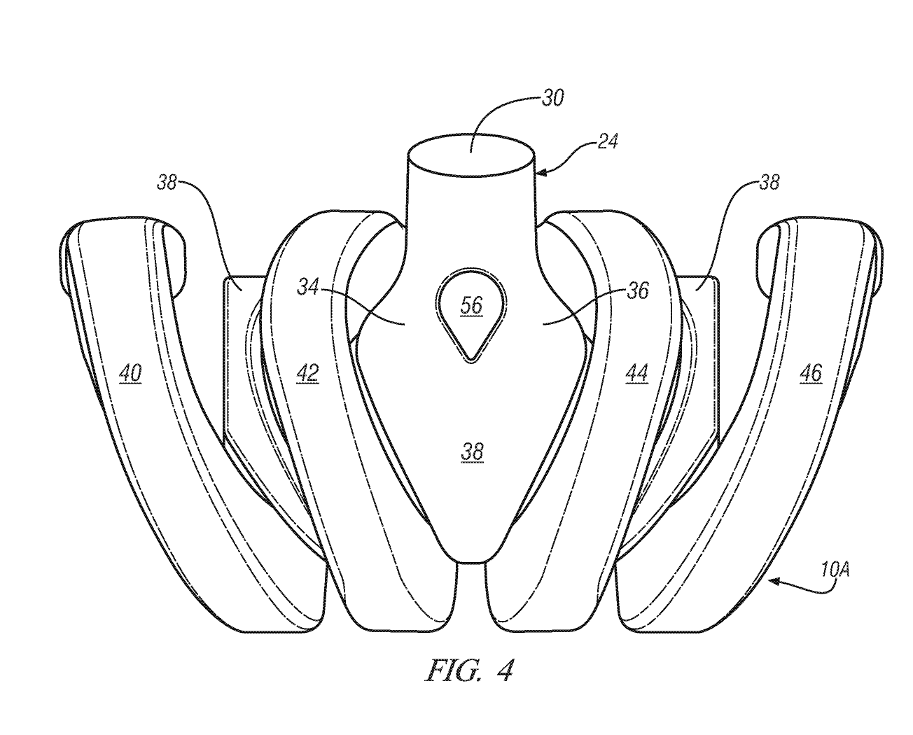

The intake manifold assembly 10 includes a centrally positioned zip tube 24 having a mounting flange 26 that is configured to receive and support a throttle body 28 thereon. The centrally positioned mounting flange 26 includes an opening 30, FIG. 4, for receipt of metered combustion air flowing through the throttle body 28 from an air induction system (not shown). The throttle body is fixed to the mounting flange 26 by suitable fasteners such as bolts 32, FIG. 2.

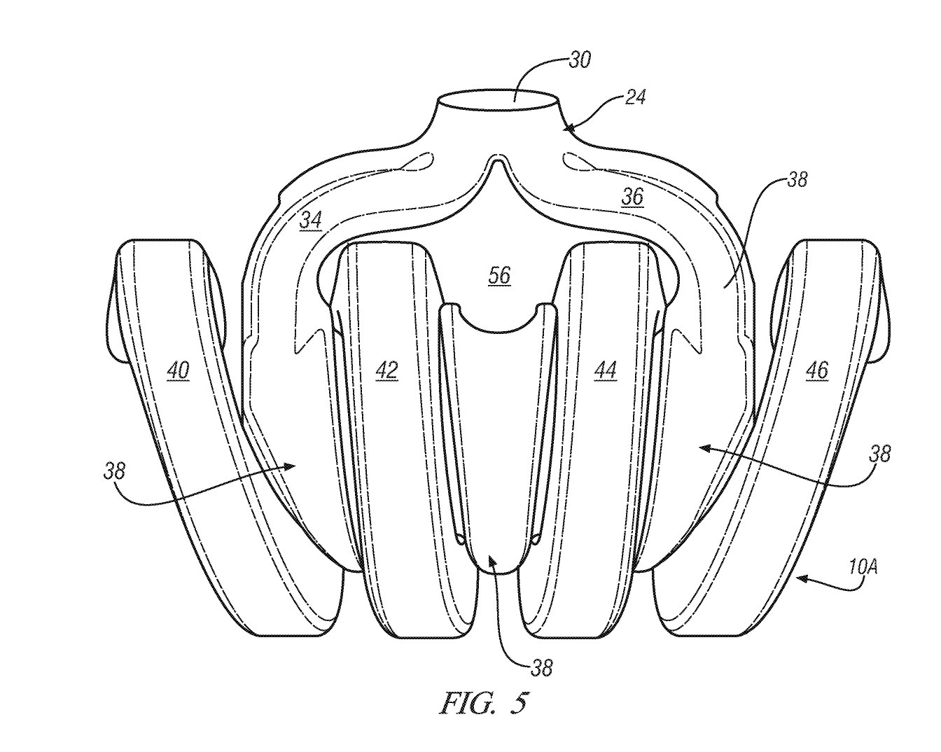

In an exemplary embodiment shown in FIGS. 2 and 5, the centrally positioned zip tube 24 bifurcates into first and second air flow runners 34 and 36 below the mounting flange 26. The first and second air flow runners 34 and 36 extend axially along the intake manifold 10 and terminate at axially remote ends of a common intake manifold plenum 38 where the combustion air flowing through the throttle body 28 and into the zip tube 24 is delivered. The intake manifold plenum 38 is configured to distribute the combustion air delivered by each of the first and second air flow runners 34 and 36 to a plurality of intake runners, in this case first, second, third and fourth intake runners 40, 42, 44, 46 that extend axially along the length of and around the circumference of the common intake manifold plenum 38 to terminate at outlet ports 48, FIG. 1, which are fluidly and sealingly connected to inlet ports (not shown) of the cylinder head 14. In an exemplary embodiment, the first and second flow runners terminate between axially spaced intake runners. More specifically, in the embodiment of FIGS. 2 and 5, first air flow runner 34 extends between first and second intake runners 40 and 42 while second air flow runner 36 extends between third and fourth intake runners 44 and 46, respectively.

The intake manifold assembly 10 is connected to the cylinder head through the use of suitable fasteners such as bolts 50 that engage a sealing flange 52 attached to the outlet end 54 of the intake runners 40, 42, 44, 46. In the exemplary embodiment of FIGS. 2 and 5, to assure a leak free seal between outlet ports 48 of the intake runners 40, 42, 44, 46 with the cylinder head 14, it is important that a consistent sealing force be applied to the sealing flange 52 along its entire length. Bifurcation of the zip tube 24 into first and second air flow runners 34 and 36 provides a centrally located access opening 56 between the second and third intake runners 42 and 44 which would not otherwise be available if the zip tube 24 delivered combustion air to the center of the intake manifold plenum 38 in a conventional single tube manner. Through the access opening 56 a fastener such as bolt 50 is easily located and effective to provide a reliable seal between the intake manifold assembly 10 the sealing flange 52 and the cylinder head 14 of the internal combustion engine 12.

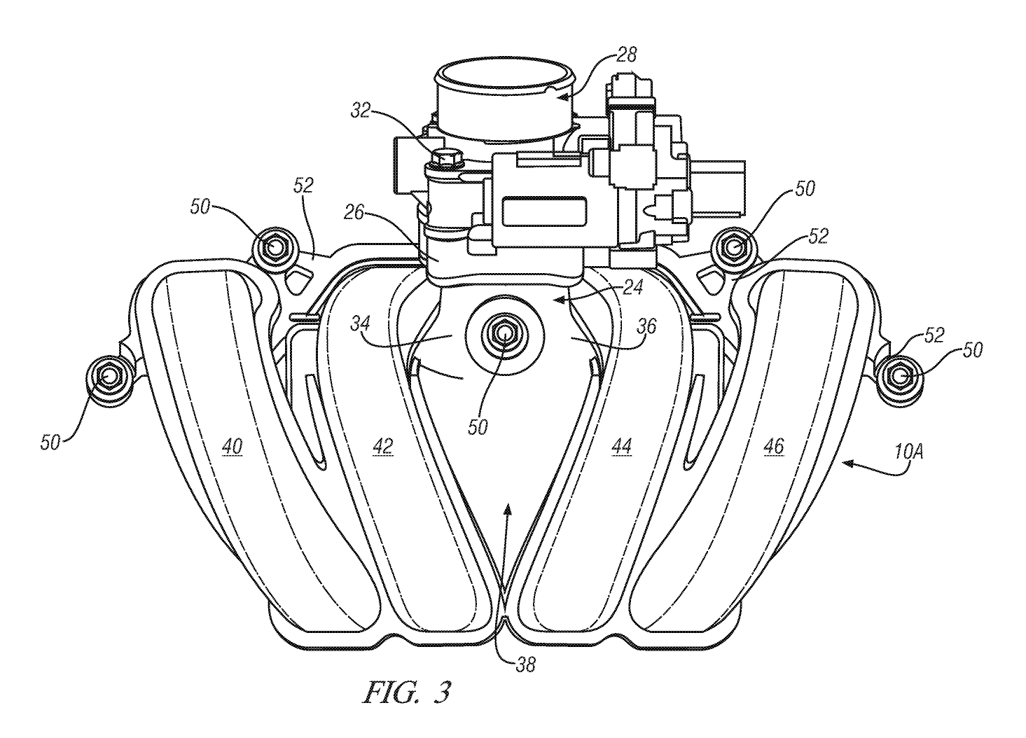

Referring now to FIGS. 1, 3 and 4, in another exemplary embodiment, the intake manifold assembly 10A includes a centrally positioned zip tube 24 having a mounting flange 26 that is configured to receive and support a throttle body 28 thereon. The mounting flange 26 includes an opening 30, FIG. 4, for receipt of metered combustion air flowing through the throttle body 28 from an air induction system (not shown). The throttle body 28 is fixed to the mounting flange 26 by suitable fasteners such as bolts 32.

The centrally mounted zip tube 24 bifurcates into two air flow runners 34 and 36 below the mounting flange 26. Combustion air flowing through the zip tube 24 is divided into two separate flow paths and is delivered to a common intake manifold plenum 38. The common intake manifold plenum 38 is configured to distribute the combustion air delivered by each of the first and second air flow runners 34 and 36, respectively, to a plurality of intake runners, in this case first, second, third and fourth intake runners 40, 42, 44, 46 that extend axially along the length and around the circumference of the common intake manifold plenum 38 to terminate at outlet ports 48, FIG. 1, which are fluidly and sealingly connected to inlet ports (not shown) of the cylinder head 14. In this exemplary embodiment, both first and second air flow runners 34 and 36 extend between second and third intake runners 42 and 44 however, bifurcation of the zip tube 24 into air flow runners 34 and 36 provides a centrally located access opening 56 therebetween which would not otherwise be available if the zip tube 24 delivered combustion air to the center of the intake manifold plenum 38 as a single tube. Through the access opening a fastener such as bolt 50 is easily located and is effective to provide a reliable seal between the intake manifold assembly 10 and the cylinder head 14 of the internal combustion engine 12 FIGS. 1, 2 and 3.

While the invention has been disclosed in an intake manifold assembly 10 having four intake runners, it is contemplated that it may just as easily have application to manifold assemblies having, for instance, six intake runners as one might find on an in-line 6 cylinder engine. Other engine configurations are also contemplated.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. An intake manifold assembly for mounting to a cylinder head and configured to deliver combustion air thereto comprising:
a centrally positioned zip tube having an opening for receipt of combustion air from a throttle body;
first and second air flow runners extending from the centrally positioned zip tube to terminate at a common intake manifold plenum for delivery of combustion air thereto; and
a centrally located access opening defined between the first and second air flow runners.

2. The intake manifold assembly of claim 1, further comprising:
a plurality of intake runners that extend axially along a length of, and around a circumference of, the common intake manifold plenum to terminate at outlet ports that are fluidly and sealingly connected to the cylinder head, wherein the first air flow runner and the second air flow runner extend between centrally located intake runners.

3. The intake manifold assembly of claim 3, further comprising:
a sealing flange that is attached to an outlet end of the plurality of intake runners; and
a fastener, located through said centrally located access opening, to engage the intake manifold, the sealing flange and the cylinder head to define a seal therebetween.

4. An intake manifold assembly for mounting to a cylinder head and configured to deliver combustion air thereto comprising:
a centrally positioned zip tube including having an opening for receipt of combustion air from a throttle body;
first and second flow runners extending from the centrally positioned zip tube to terminate at axially remote ends of a common intake manifold plenum; and
a centrally located access opening defined between the second and third flow runners.

5. The intake manifold assembly of claim 5, further comprising:
first, second, third and fourth intake runners fluidly connected to the common intake manifold plenum and configured to transport combustion air from the common intake manifold plenum to the cylinder head and having the first and second flow runners terminating between the first and second and the third and forth intake runners respectively.

6. The intake manifold assembly of claim 5, further comprising:
a sealing flange that is attached to an outlet end of the first, second, third and fourth intake runners; and
a fastener located through said centrally located access opening to engage the intake manifold, the sealing flange and the cylinder head to define a seal therebetween.

7. The intake manifold assembly of claim 5, further comprising:
a plurality of intake runners fluidly connected to the common intake manifold plenum and configured to transport combustion air from the common intake manifold plenum to the cylinder head and having the first and second flow runners terminating between axially spaced intake runners.
